(19) United States
(12) Patent Application Publication
(10) Pub. No.: US 2021/0392432 A1
(43) Pub. Date: Dec. 16, 2021

(54) Microspeaker Module having Duct Communicating with Vent Hole

(71) Applicant: EM-TECH Co., Ltd., Gyeongsangnam-do (KR)

(72) Inventors: Ji Hoon Kim, Gyeongsangnam-do (KR); In Ho Jeong, Gyeongsangnam-do (KR); Jong Heon Ha, Gyeongsangnam-do (KR); Min Chul Kang, Gyeongsangnam-do (KR); Won Ki Lee, Gyeongsangbuk-do (KR); Chi Kyun Kim, Gyeongsangnam-do (KR)

(21) Appl. No.: 17/344,282

(22) Filed: Jun. 10, 2021

(30) Foreign Application Priority Data
Jun. 12, 2020 (KR) 10-2020-0071765
May 28, 2021 (KR) 10-2021-0069459

(51) Int. Cl. H04R 1/28

(52) U.S. Cl. CPC H04R 1/2849

(57) ABSTRACT

Provided is a microspeaker module having a duct communicating with a back volume vent hole. The microspeaker module includes a case, a microspeaker, and a circuit part and is mounted in a multimedia device to generate sound. The microspeaker includes a back volume communicating with a rear of the microspeaker and defined by the case, a vent hole formed in the case and configured to allow air to flow into and out of the back volume, and a duct connected to the vent hole to increase a path of air flowing to the vent hole.

### TECHNICAL FIELD

The present disclosure relates to a microspeaker module having a duct communicating with a back volume vent hole.

### BACKGROUND

FIG. 1 is a plan view of a microspeaker module according to the related art, FIG. 2 is a view illustrating a vent hole of a microspeaker module according to the related art, and FIG. 3 is a cross-sectional view of a microspeaker module according to the related art.

A microspeaker module refers to a component modularized by coupling a microspeaker 1 to cases 10 and 11 (i.e., a lower case 10 and an upper case 11) including a back volume 12 and a circuit part so as to be mounted in a multimedia device. The back volume 12 is a space defined by the lower case 10 and the upper case 11 and communicating with a rear of the microspeaker 1.

The back volume 12 communicates with the rear of the microspeaker 1, in which a flow of air is formed so that a diaphragm of the microspeaker 1 may move smoothly.

Here, if the back volume 12 is not ventilated at all and is blocked, a temperature of internal air rises due to heat of a voice coil included in the microspeaker and pressure inside the back volume 12 increases. Thus, a vent hole 13 for releasing pressure when the internal pressure of the back volume 12 increases is provided in the upper case 11 defining the back volume 12.

However, if airtightness of the back volume 12 is low, that is, if air permeability of the vent hole 13 is too good, amplitude characteristics are deteriorated.

In the related art, a circular recess 14 is provided around the vent hole 13 of the upper case 11 and a mesh 15 is attached in the recess 14 to lower air permeability. That is, the amplitude characteristics of the related art vent hole 13 is determined depending on air permeability of the mesh 15.

However, it is difficult to implement the mesh 150 to have air permeability below a specific value, and thus, there is a limitation in turning amplitude characteristics.

### SUMMARY

An aspect of the present disclosure provides a ventilation structure capable of increasing the degree of airtightness, while preventing an increase in pressure in a back volume due to an increase in temperature.

According to an aspect of the present disclosure, a microspeaker module including a case, a microspeaker, and a circuit part and mounted in a multimedia device to generate sound, including: a back volume communicating with a rear of the microspeaker and defined by the case; a vent hole formed in the case and allowing air to flow into and out of the back volume therethrough; and a duct connected to the vent hole to elongate a path of air flowing to the vent hole.

In another example of the present disclosure, the duct may be connected to the vent hole on one side and may be branched into two or more ducts on an outer side.

In another example of the present disclosure, the duct may be provided in the case and may be defined by a film attached to a groove connected to the vent hole and the case.

In another example of the present disclosure, the groove may extend from the vent hole so as to be branched into two or more grooves, and the film may seal at least one of the branched grooves to select a length of an effective ventilation duct.

In another example of the present disclosure, an end of the groove may extend to an outer side than the film.

In another example of the present disclosure, the case may include a circular concave step portion around the vent hole, and the duct may be defined by a groove formed on an upper surface of the step portion and communicating with the vent hole and a film attached to an upper surface of the groove.

In another example of the present disclosure, an end of the groove may extend to the outside of the circular step portion and may not be covered by the film.

In another example of the present disclosure, the duct may extend to surround the vent hole.

In another example of the present disclosure, the duct may extend in zigzags to the outside of the vent hole to increase an effective length.

In another example of the present disclosure, the duct may be provided on an outer surface of the case.

In another example of the present disclosure, the duct may be provided on an inner surface of the case, and air flowing in through the duct from the back volume may flow into or out of the case through the vent hole.

In the microspeaker module according to the present disclosure, air flowing in and out through the vent hole communicating with the back volume is allowed to pass through the duct, thereby increasing flow resistance of air to prevent an increase in internal pressure due to an increase in temperature in the back volume, while air tightness of the back volume is increased.

Those skilled in the art will recognize additional features and advantages upon reading the following detailed description, and upon viewing the accompanying drawings.

### BRIEF DESCRIPTION OF THE DRAWINGS

FIG. 1 is a plan view of a microspeaker module according to the related art;

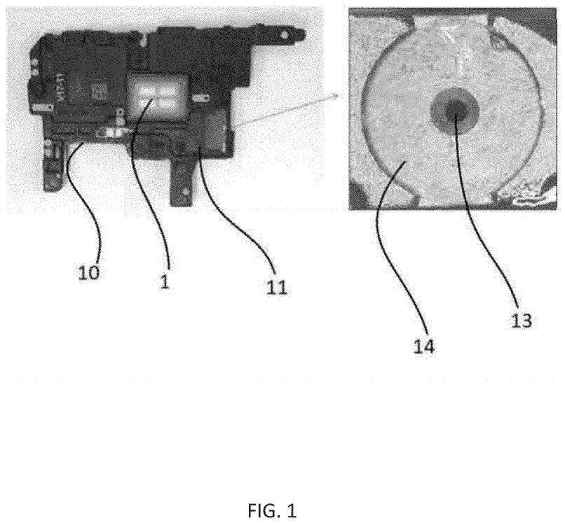

FIG. 2 is a view illustrating a vent hole of a microspeaker module according to the related art;

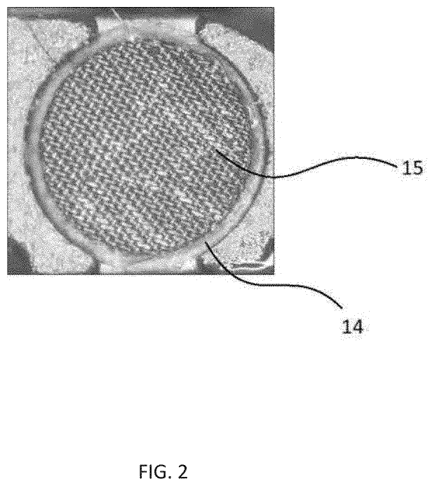

FIG. 3 is a cross-sectional view of a microspeaker module according to the related art;

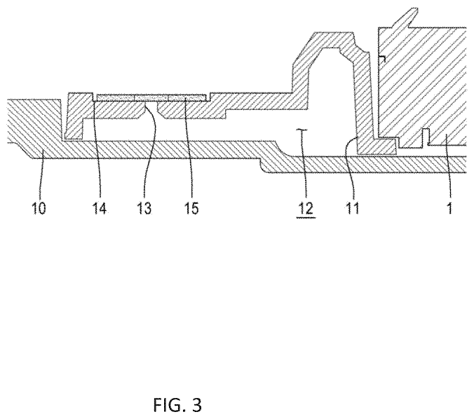

FIG. 4 is a plan view of a microspeaker module according to a first embodiment of the present disclosure;

FIG. 5 is a view illustrating a vent hole and duct structure of a microspeaker module according to the first embodiment of the present disclosure;

FIG. 6 is a cross-sectional view of a microspeaker module according to the first embodiment of the present disclosure;

FIG. 7 is a view illustrating a vent hole and duct structure of a microspeaker module according to a second embodiment of the present disclosure;

FIG. 8 is a view illustrating a vent hole and duct structure of a microspeaker module according to a third embodiment of the present disclosure;

FIG. 9 is a view illustrating a vent hole and duct structure of a microspeaker module according to a fourth embodiment of the present disclosure;

FIG. 10 is a view illustrating a vent hole and duct structure of a microspeaker module according to a fifth embodiment of the present disclosure;

FIG. 11 is a view illustrating a state in which only a long duct of a vent hole and duct structure of a microspeaker module according to a sixth embodiment of the present disclosure is opened;

FIG. 12 is a view illustrating a state in which only a short duct of a vent hole and duct structure of a microspeaker module according to the sixth embodiment of the present disclosure is opened;

FIG. 13 is a perspective view illustrating an inner surface of a microspeaker module according to a seventh embodiment of the present disclosure;

FIG. 14 is a cross-sectional perspective view of a microspeaker module according to the seventh embodiment of the present disclosure;

FIG. 15 is a graph showing comparison of electrical characteristics of a microspeaker module according to the related art and a microspeaker module according to an embodiment of the present disclosure;

FIG. 16 is a graph illustrating an amplitude deviation of upper and lower sides of a diaphragm of a microspeaker module according to the related art; and

FIG. 17 is a graph illustrating an amplitude deviation of upper and lower sides of a diaphragm of a microspeaker module according to the present disclosure.

### DETAILED DESCRIPTION

Hereinafter, the present disclosure will be described in more detail with reference to the accompanying drawings.

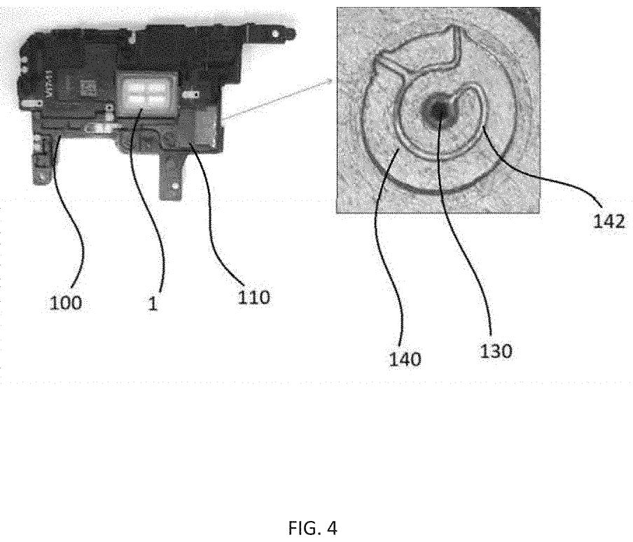

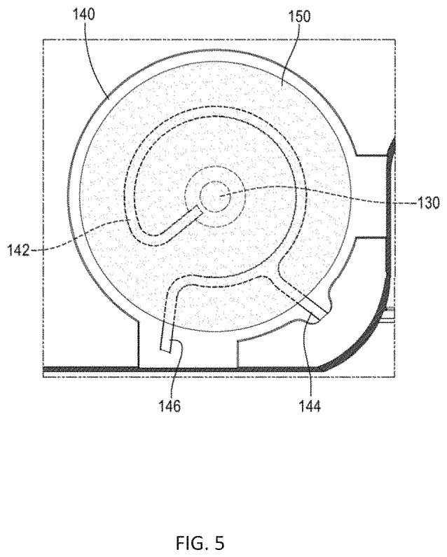

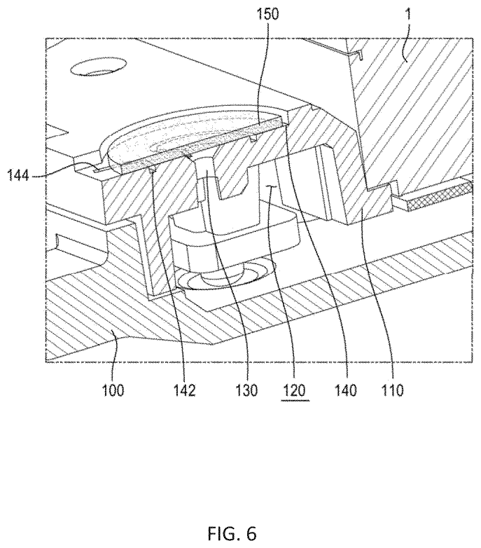

FIG. 4 is a plan view of a microspeaker module according to an embodiment of the present disclosure, FIG. 5 is a view illustrating a vent hole of a microspeaker module according to an embodiment of the present disclosure, and FIG. 6 is a cross-sectional view of a microspeaker module according to an embodiment of the present disclosure.

A microspeaker module refers to a component modularized by coupling a microspeaker 1 to cases 100 and 110 (i.e., a lower case 100 and an upper case 110) including a back volume 120 and a circuit part so as to be mounted in a multimedia device. The back volume 120 is a space defined by the lower case 100 and the upper case 110 and communicating with a rear of the microspeaker 1.

The back volume 120 communicates with the rear of the microspeaker 1, in which a flow of air is formed so that a diaphragm of the microspeaker 1 may move smoothly.

Here, if the back volume 120 is not ventilated at all and is blocked, a temperature of internal air rises due to heat of a voice coil included in the microspeaker and pressure inside the back volume 12 increases. Thus, a vent hole 130 is provided in the upper case 110 defining the back volume 120 to prevent an increase in pressure.

A circular concave step portion 140 is formed around the vent hole 130 of the upper case 110, and a groove 142 communicating with the vent hole 130 is formed in the step portion 140. A non-breathable film 150 is attached to the step portion 140, and a duct is defined by the film 150 and the groove 142. The ends 144 and 146 of the groove 142 extend to the outside of the circular step portion 140 and are not covered by the film 150. Accordingly, air discharged through the vent hole 130 is discharged through the ends 144 and 146 of the groove 142 through the duct defined by the groove 142 and the film 150. That is, the back volume 120 has a structure in which only pressure equalization is achieved in a closed state as much as possible, which is advantageous in improving amplitude characteristics.

This duct type ventilation structure is a structure in which air permeability is easily adjusted by adjusting a length/width of the semi-open duct, and it is advantageous for tuning amplitude characteristics because air permeability below a certain value may be implemented. Here, the good amplitude characteristics means that a difference in amplitude between upper and lower sides of a center diaphragm for each frequency when the microspeaker 1 is excited is small.

Meanwhile, as the length of the duct connected to the vent hole 130 increases, resistance of air flow increases and air permeability decreases, and as a cross-section of the duct decreases, resistance of air flow increases and air permeability decreases.

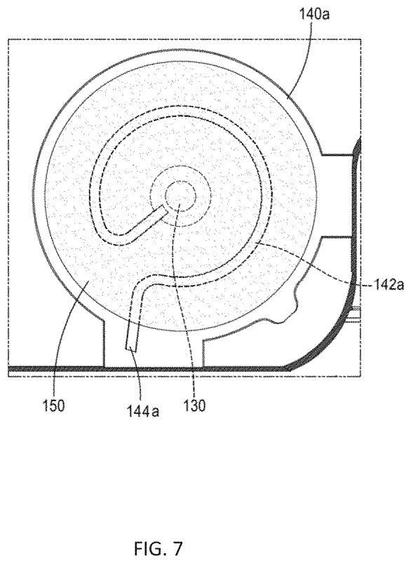

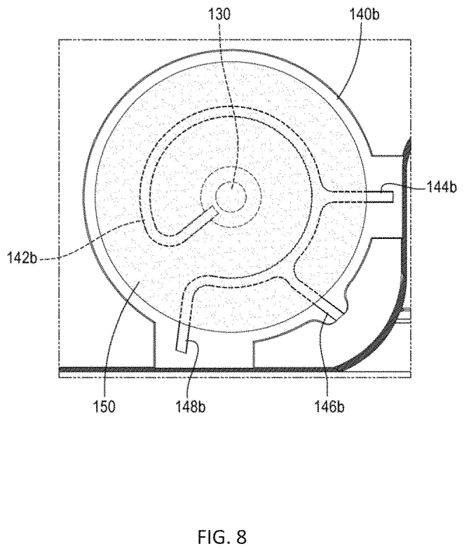

FIG. 7 is a view illustrating a vent hole and duct structure of a microspeaker module according to a second embodiment of the present disclosure, and FIG. 8 is a view illustrating a vent hole and duct structure of a microspeaker module according to a third embodiment of the present disclosure.

In the second embodiment of the present disclosure, the duct has one outlet, and the third embodiment of the present disclosure is the same as the first embodiment except that the duct has three outlets.

That is, concave step portions 140a and 140b are formed around the vent hole 130, and grooves 142a and 142b having a predetermined shape connected to the vent hole 130 are formed in the step portions 140a and 140b, and the film 150 is attached to the step portions 140a and 140b, so that the duct is defined by the grooves 142a and 142b and the film 150. The outlet of the duct becomes outlet-side ends 144a, 144b, 146b, and 148b of the grooves 142a and 142b extending outward of the film 150. Here, in the second embodiment, there is one outlet-side end 144a of the groove 142a extending outward of the film 150, and there are three outlet-side ends 144b, 146b, and 148b of the groove 142b extending outward of the film 150.

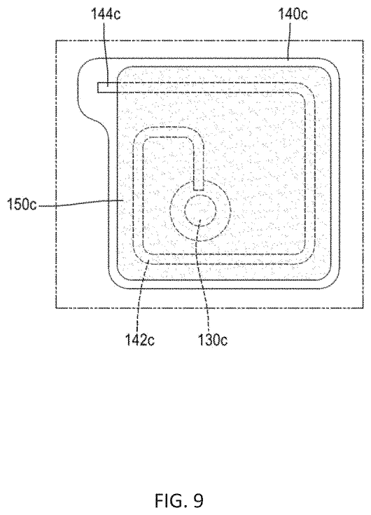

FIG. 9 is a view illustrating a vent hole and duct structure of a microspeaker module according to a fourth embodiment of the present disclosure.

In a vent hole and duct structure of the microspeaker module according to the fourth embodiment of the present disclosure, a concave step portion 140c formed around a vent hole 130c is rectangular, and a film 150c attached to the step portion 140c is rectangular. In addition, a groove 142c having a predetermined shape formed in the step portion 140c and connected to the vent hole 130 also has an angled spiral shape.

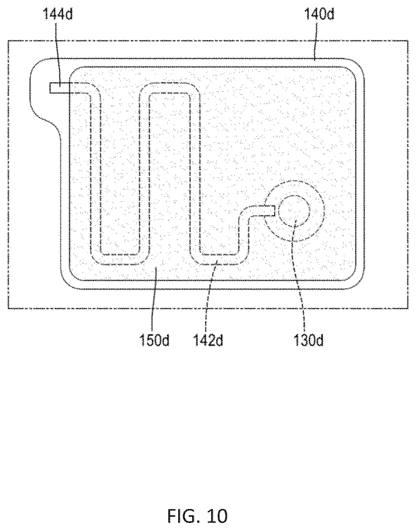

FIG. 10 is a view illustrating a vent hole and duct structure of a microspeaker module according to a fifth embodiment of the present disclosure.

In the vent hole and duct structure of the microspeaker module according to the fifth embodiment of the present disclosure, a concave step portion 140d formed around a vent hole 130d is rectangular, and a film 150d attached to the step portion 140d is also rectangular. Here, a groove 142d having a predetermined shape formed in the step portion 140d and connected to the vent hole 130d to form a duct has an angular zigzag shape.

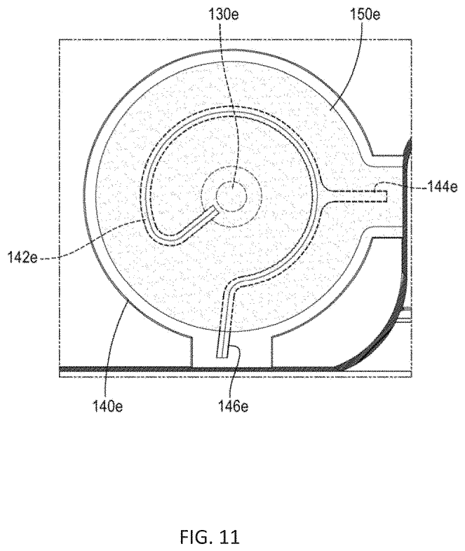

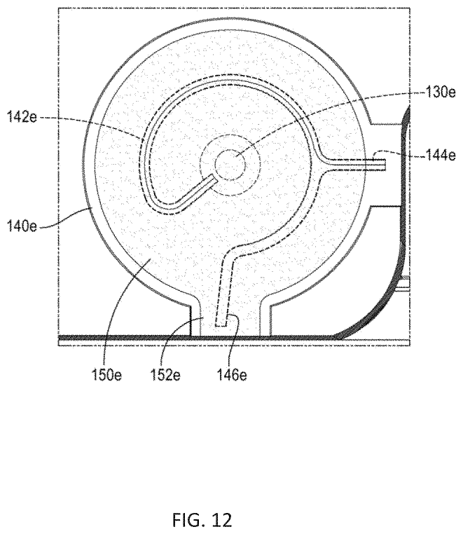

FIG. 11 is a view illustrating a state in which only a long duct of a vent hole and duct structure of a microspeaker module according to a sixth embodiment of the present disclosure is opened. FIG. 12 is a view illustrating a state in which only a short duct of a vent hole and duct structure of a microspeaker module according to the sixth embodiment of the present disclosure is opened.

In the vent hole and duct structure of the microspeaker module according to the sixth embodiment of the present disclosure, that is, a concave step portion 140e is formed around a vent hole 130e, a groove 142e having a predetermined shape connected to the vent hole 130e is formed in the step portion 140e, and a film 150e is attached to the step portion 140e, so that a duct is defined by the groove 142e and the film 150e.

Here, air discharged through the vent hole 130e is discharged through ends 144e and 146e of the groove 142e through the duct defined by the groove 142e and the film 150e. The ends 144e and 146e include a first end 144e forming a shorter duct and a second end 146e forming a longer duct, and the first end 144e and the second duct 146e are branched from certain positions.

The film 150e has an extension that further extends outward to close either the first end 144e or the second end 146e. In FIG. 11, a perimeter of the first end 144e is closed by the film 150e, and only the longer duct formed by the second end 146e serves to allow the vent hole 130e to communicate with the outside. Conversely, in FIG. 12, a perimeter of the second end 146e is closed by the film 150e, and only the shorter duct formed by the first end 144e serves to allow the vent hole 130e to communicate with the outside.

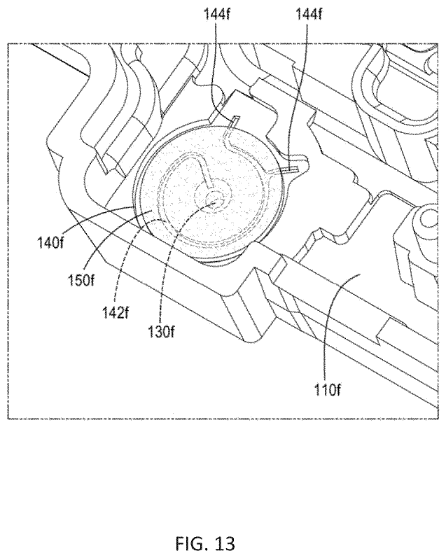

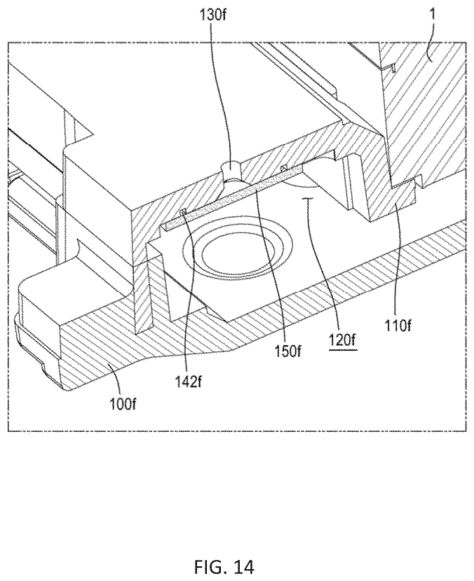

FIG. 13 is a perspective view illustrating an inner surface of a microspeaker module according to a seventh embodiment of the present disclosure, and FIG. 14 is a cross-sectional perspective view of a microspeaker module according to the seventh embodiment of the present disclosure. In the first embodiment of the present disclosure, the duct is formed on the outer surface of the upper case, but in the seventh embodiment of the present disclosure, a duct is formed on an inner surface of an upper case 110f.

A circular concave step portion 140f is formed around a vent hole 130f of the upper case 110f, and a groove 142f communicating with the vent hole 130f is formed in the step portion 140f. A non-breathable film 150f is attached to the step portion 140f, and a duct is defined by the film 150f and the groove 142f. Ends 144f and 146f of the groove 142f extend to the outside of the circular step portion 140f and are not covered by the film 150f. Here, unlike the first embodiment, air flows into the duct through the ends 144f and 146f of the groove 142f and then discharged through the vent hole 130f. However, by performing the same mechanics as in the first embodiment, only pressure equalization is achieved in a state in which a back volume 120f is maximally sealed. Therefore, it is advantageous to improve amplitude characteristics of the microspeaker module.

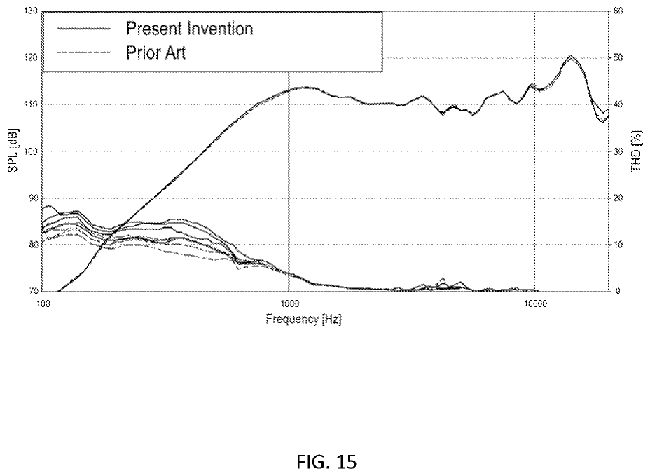

FIG. 15 is a graph showing a comparison of electrical characteristics of a microspeaker module according to the related art and a microspeaker module according to an embodiment of the present disclosure. It can be seen that there is no significant difference in sound pressure level (SPL) but total harmonic distortion (THD) is improved in a low frequency band (100 to 600 Hz) due to improvement of amplitude balance.

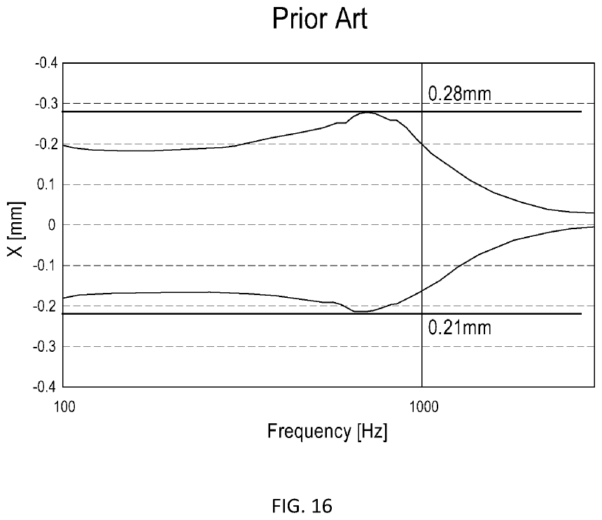

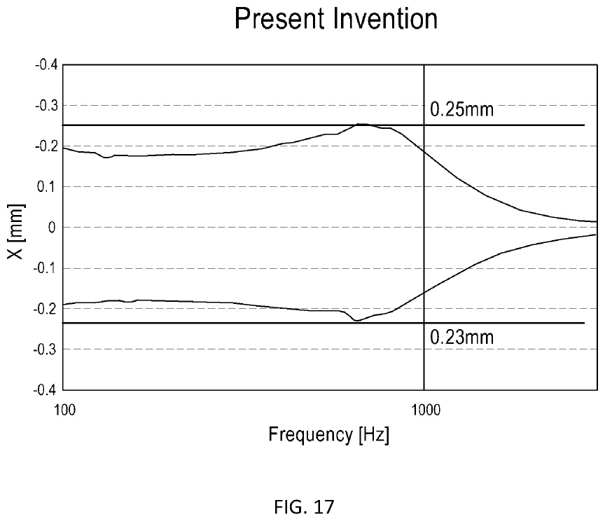

FIG. 16 is a graph illustrating an amplitude deviation of upper and lower sides of a diaphragm of the microspeaker module according to the related art, and FIG. 17 is a graph illustrating an amplitude deviation of upper and lower sides of a diaphragm of a microspeaker module according to the present disclosure.

An amplitude absolute amount is the sum of an upper amplitude absolute value and a lower amplitude absolute value, and it can be seen that the amplitude absolute amount is the same in the related art and in the present disclosure. However, referring to amplitude balance, it can be seen that an upper and lower amplitude deviation in the related art is 0.07 mm, whereas an upper and lower amplitude deviation in the present disclosure is 0.02 mm, which is significantly smaller.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A microspeaker module including a case, a microspeaker, and a circuit part and mounted in a multimedia device to generate sound, the microspeaker comprising:
a back volume communicating with a rear of the microspeaker and defined by the case;
a vent hole formed in the case and configured to allow air to flow into and out of the back volume therethrough; and
a duct connected to the vent hole to elongate a path of air flowing to the vent hole.

2. The microspeaker of claim 1, wherein the duct is connected to the vent hole on one side and is branched into two or more ducts on an outer side.

3. The microspeaker of claim 1, wherein the duct is provided in the case and is defined by a film attached to a groove connected to the vent hole and the case.

4. The microspeaker of claim 3, wherein the groove extends from the vent hole so as to be branched into two or more grooves, and wherein the film seals at least one of the branched grooves to select a length of an effective ventilation duct.

5. The microspeaker of claim 3, wherein an end of the groove extends to an outer side than the film.

6. The microspeaker of claim 1, wherein the case includes a circular concave step portion around the vent hole, and wherein the duct is defined by a groove formed on an upper surface of the step portion and communicates with the vent hole and a film attached to an upper surface of the groove.

7. The microspeaker of claim 6, wherein an end of the groove extends to an outside of the circular step portion and is not covered by the film.

8. The microspeaker of claim 1, wherein the duct extends to surround the vent hole.

9. The microspeaker of claim 1, wherein the duct extends in zigzags to the outside of the vent hole to increase an effective length.

10. The microspeaker of claim 1, wherein the duct is provided on an outer surface of the case.

11. The microspeaker of claim 1, wherein the duct is provided on an inner surface of the case, and wherein air flowing in through the duct from the back volume flows into or out of the case through the vent hole.
